(19) United States
(12) Patent Application Publication
(10) Pub. No.: US 2016/0048296 A1
(43) Pub. Date: Feb. 18, 2016

(54) Methods for Implementing a Display Theme on a Wearable Electronic Device

(71) Applicant: Motorola Mobility LLC, Chicago, IL (US)

(72) Inventors: Su-Yin Gan, San Francisco, CA (US); Ravi Jain, Palo Alto, CA (US)

(21) Appl. No.: 14/457,500

(22) Filed: Aug. 12, 2014

(51) Int. Cl. G06F 3/0484; G06F 3/0482; H04L 29/08; G09G 5/00

(52) U.S. Cl. CPC G06F 3/04842; G09G 5/006; G06F 3/0482; H04L 67/10; G09G 2370/16

(57) ABSTRACT

A user controls a pair of devices—a wearable electronic device, such as a watch (e.g., a smart watch) and a companion electronic device, such as a smart phone. The user takes a picture (of him or herself or of something in the environment) with the companion electronic device. The companion electronic device transfers information about attributes of the image (or, in some embodiments, transfers the image itself) to the wearable device. The wearable electronic device changes its appearance based on one or more attributes of the image, including color and the identity of objects in the picture. For example, if the wearable electronic device is a watch and the user is wearing pink, the watch could change its display to pink or to a complementary color. If user is wearing jeans (determined by object recognition, for example), the watch could change its display to a Western theme.

### TECHNICAL FIELD

The present disclosure is related generally to electronic devices and, more particularly, to implementing a display theme on a wearable electronic device.

### BACKGROUND

Personalization of user interfaces of electronic devices has been a desired feature among users of such devices for several years. Users are now able to change color schemes, fonts, and background images of devices such cell phones and tablet computers. Generally, to customize the user interface, users need to select from various themes that are either provided by the electronic device “out of the box” or select from various image files that the user has acquired (e.g., by downloading).

### DRAWINGS

While the appended claims set forth the features of the present techniques with particularity, these techniques, together with their objects and advantages, may be best understood from the following detailed description taken in conjunction with the accompanying drawings of which:

FIG. 1 is block diagram depicting a wearable electronic device according to an embodiment;

FIG. 2 is a block diagram depicting a companion electronic device according to an embodiment;

FIG. 3 is a block diagram depicting a wearable electronic device, a companion device, a public network, and a server according to an embodiment; and

FIGS. 4-6 are process flow diagrams that illustrate the operation of different embodiments.

### DESCRIPTION

This disclosure is generally directed to methods for implementing a display theme on a wearable electronic device. In an embodiment, a user controls a pair of devices—a wearable electronic device, such as a watch (e.g., a smart watch) and a companion electronic device, such as a smartphone. The user takes a picture (of himself or herself or of something in the environment) with the companion electronic device. The companion electronic device transfers information about attributes of the image (or, in some embodiments, transfers the image itself) to the wearable electronic device. The wearable electronic device changes its appearance based on one or more attributes of the image, including the color and the identity of objects in the picture. For example, if the wearable electronic device is a watch and the user is wearing pink, the watch could change its display to pink or to a complimentary color. If the user is wearing jeans (determined by object recognition, for example), the watch could change its display to a Western theme.

In some embodiments, it is the companion electronic device (i.e., the device having the camera) that makes the decision as to whether to implement a particular display theme based on the image attributes. In other embodiments, it is the wearable electronic device that makes this decision. In either case, the companion electronic device may also implement a display theme based on the image attributes.

According to various embodiments, the wearable electronic device (“wearable device”) or the companion electronic device (“companion device”) selects a display theme for the wearable device based not only on attributes of an image taken by the companion device, but also on one or more context indicators. A context indicator is a piece of information that indicates something about the context in which the wearable device or the companion device is being used or the state of the user. Examples of context indicators include the time (of the day, week, month, year, or season), motion [(e.g., whether the user is driving, whether the user is exercising (as determined by measured heart rate and motion)], location (e.g., whether or not the user is at work or the country in which the user is located), the user's age, the user's gender, and the weather. In another example, if the wearable device or companion device determines that the user is at work (e.g., based on a global positioning system signal and the user setting that location to be “work”), the wearable device or companion device may select a more conservative display theme than it would if it determined that the user was located at a club. Other examples of context indicators include information that indicates the user's mood, such as the user's heart rate (detected by a heart rate monitor on the wearable device or companion device), calendar data (e.g., events from the user's calendar), and events identified from location information combined with time. For example, if the wearable device or companion device detects, based on the time, date, and location, that the user is at the Burning Man® festival, then the device may select a Burning Man® display theme. In another example, the companion device might be aware that the user is a San Francisco Giants® fan and, based on its location, may be aware that the user is currently at AT&T® Park watching a game. Based on this knowledge, the wearable device could change its display to show a San Francisco Giants® theme and update itself with every change in score. At the end of the game, the wearable device could also find out whether the team won or lost and, if the team won, show a celebratory theme. Other examples of context information may be crowd-sourced. In other words, the wearable device might select (or have selected for it by the companion device) a display theme that is popular among nearby users at that moment.

In still other embodiments, the wearable device or the companion device selects a display theme based on the user's demonstrated preferences. For example, the user's previous choices of display themes might indicate whether the user is conservative or flamboyant, and the wearable device or the companion device would select a display theme accordingly. When the user selects or rejects a display theme suggestion, the wearable device or companion devices uses such feedback to develop a machine learning process to refine future suggestions. For example, younger users may prefer a certain palette but a particular user, who is young, may demonstrate a palette preference normally associated with older users. In general, the wearable device or companion device can incorporate the feedback into a learning process that is run on the wearable device, the companion device, a remove server, or some combination thereof.

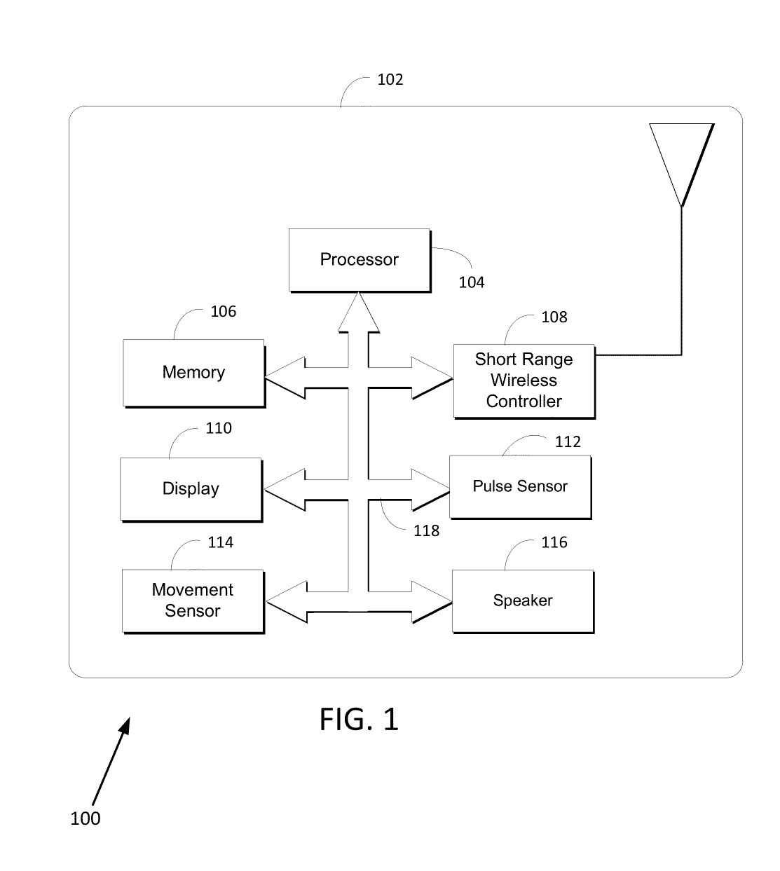

Turning to FIG. 1, a wearable electronic device 100 (“wearable device 100”) according to an embodiment includes a housing 102. The housing 102 may take a variety of forms, including a ring, wrist device (e.g., a wristwatch), and a pair of glasses. Within the housing 102 is a processor 104. Several components are communicatively linked to the processor 104, including a memory 106, a short-range wireless controller 108 (e.g., a Bluetooth® controller or a near-field communication controller), a display 110 (e.g., an organic light emitting diode watch face), a pulse sensor 112, a movement sensor 114 (e.g., an accelerometer), and a speaker 116. The memory 106 may be volatile, non-volatile, or a combination thereof.

The elements of FIG. 1 are communicatively linked to one another via one or more data pathways 118. Possible implementations of the data pathways 118 include wires and conductive pathways on a microchip. Possible implementations of the processor 102 include a microprocessor and a controller. When the disclosure refers to the wearable device 100 carrying out an action, it is (in many embodiments) the processor 102 that carries out the action in cooperation with other components as necessary).

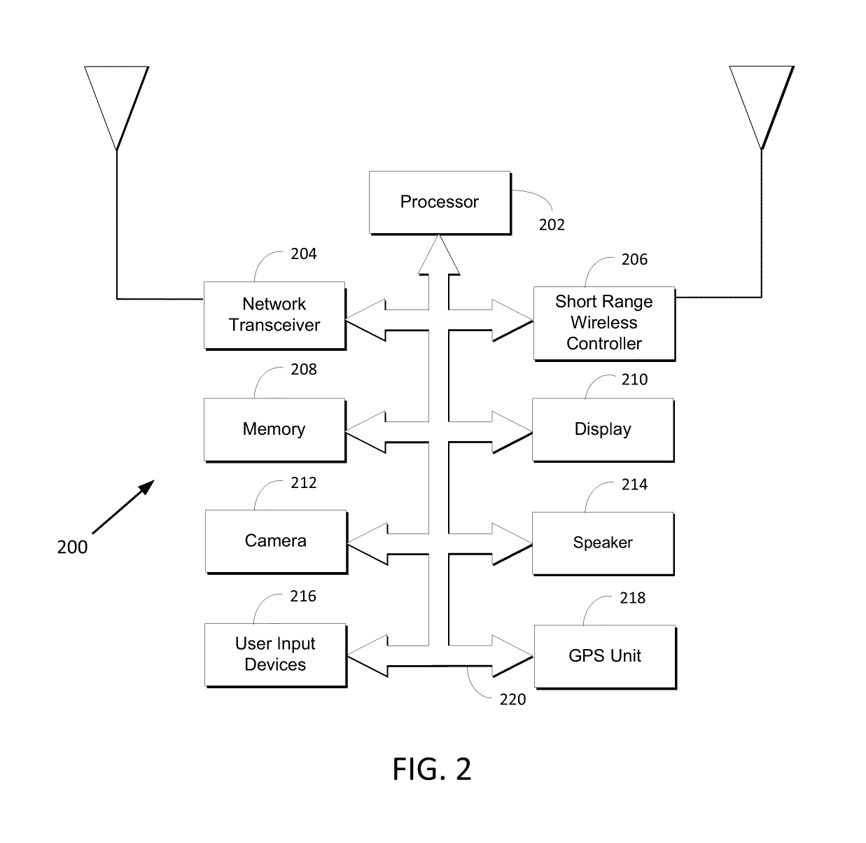

Turning to FIG. 2, a companion device 200 according to an embodiment includes a processor 202. Several components are communicatively linked to the processor 202, including a network transceiver 204, a short-range wireless controller 206 (e.g., a Bluetooth® controller or a near-field communication controller), a memory 208, a display 210, a camera 212, a speaker 214, user input devices 216 (e.g., a capacitive touch screen, microphones, and physical buttons), and a global positioning system (“GPS”) unit 218. The short-range wireless controller 206 includes a transceiver. In some implementations, the processor 202 transmits data via wireless local area network or cellular network using the network transceiver 204. The elements of FIG. 2 are communicatively linked to one another via one or more data pathways 220. Possible implementations of the data pathways 220 include wires and conductive pathways on a microchip. Possible implementations of the processor 202 include a microprocessor and a controller. The memory 208 may be volatile, non-volatile, or a combination thereof.

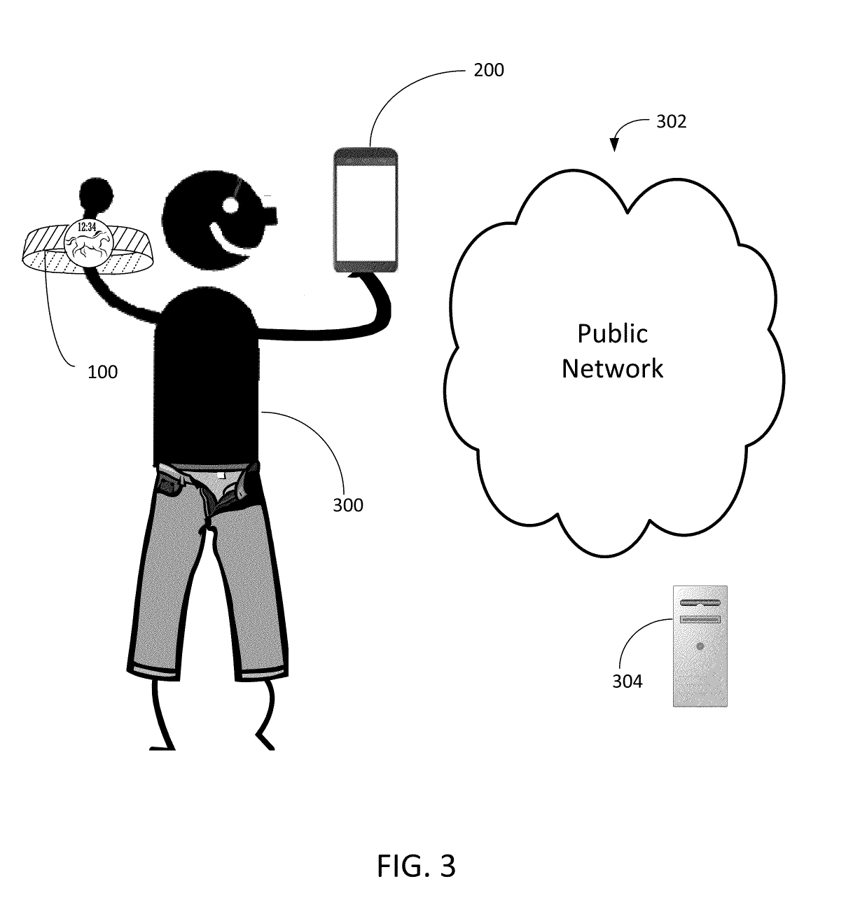

In an embodiment, the wearable device 100 and the companion device 200 communicate with one another using their respective short range wireless controllers (e.g., via a Bluetooth® connection). Turning to FIG. 3, an example use case for the disclosure is as follows. A user 300 is wearing the wearable device 100 and also has the companion device 200. Although the wearable device 100 is depicted as a smart watch and the companion device 200 is depicted as a smart phone, many other implementations are possible. The companion device 200 communicates with a public network 302 via the network transceiver 204. In some embodiments, the companion device 200 communicates with a remote server 304, as will be described in further detail below.

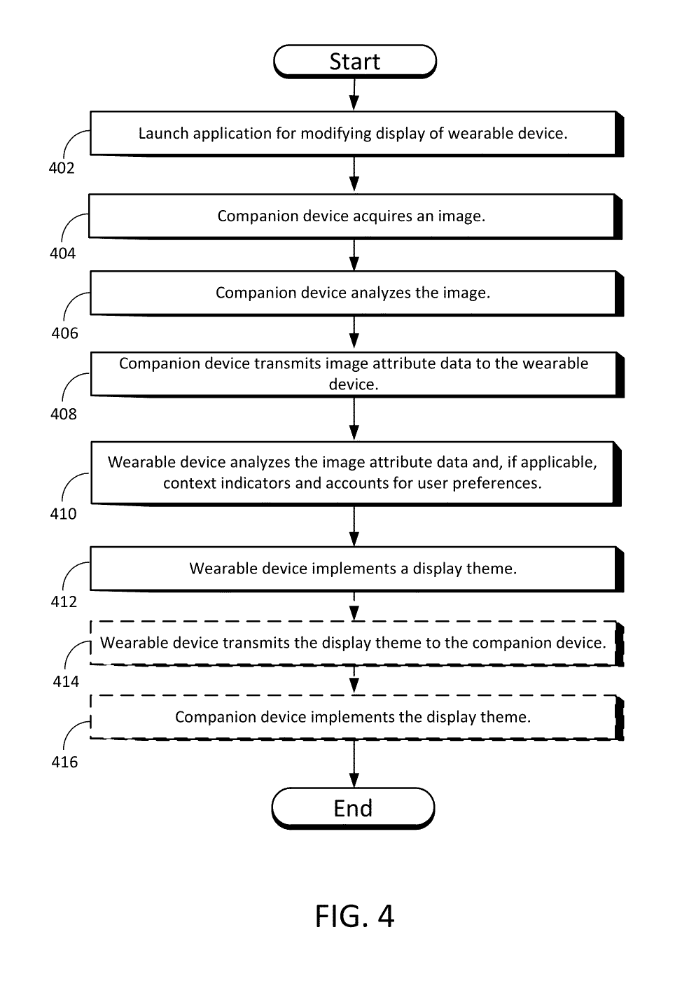

Turning to FIG. 4, operation of the wearable device 100 and the companion device 200 according to an embodiment is described. At block 402, the wearable electronic device 100 or the companion device 200 launches (e.g., in response to input from the user 300) an application stored in the memory 106 of the wearable electronic device 100 or in the memory 208 of the companion device 200, the purpose of which is to modify the appearance of the display 110 of the wearable electronic device 100. At block 404, the companion device 200 acquires an image of the user 300 using the camera 212, either automatically or in response to user input (e.g., after prompting the user to take a self-portrait). At block 406, the companion device 200 analyzes the image to determine attributes of the image, such as the color of the clothing being worn by the user 300. Other attributes of the image may include, for example, information regarding the surroundings of the user and the predominant colors found in the image. The companion device 200 then provides data regarding the attributes to the wearable electronic device 100 via the short range wireless controller 206 at block 408.

Upon receipt of the attribute data, at block 410, the wearable device 100 analyzes the image attribute data and, if applicable, context indicators and user preferences. In this regard, depending upon user preferences stored in the memory 110, the wearable device 100 could take into consideration context indicators in addition to those present in the attribute data of the image acquired by the companion device 200. Additional context indicators may include static indicators, such as the user's age, gender, or country of citizenship. Other context indicators may include dynamic indicators, such as the current weather, the user's location, the day of the week (or other calendar data), crowd-sourced data, and the time of day. In addition, a current activity state of the user as determined by a heart rate detected by the pulse sensor 112 and stored in the memory 110 could also provide a dynamic indicator. Static indicators, such as age, gender, or citizenship, may be stored in the memory 110 of the wearable electronic device 100, for example, as a user profile. Alternatively, static indicators and dynamic indicators could be stored on the server 304, and the wearable device 100 could obtain those indicators via the companion device 200, which would access the indicators via the public network 302. In some embodiments, the context indicators are a pre-determined combination of indicators, such as the kind users may set up with Google Now™ Cards.

At block 412, the wearable device 100 implements a display theme based on the analysis conducted at block 410. The display theme could be one of several themes stored in the memory 106 of the wearable device 100. According to an embodiment, the display theme is based on a predefined color theme that corresponds to a detected color palette of the user's clothing determined from the image. For example, in FIG. 3, the user 300 is wearing blue jeans, so the wearable device 100 shows a western theme (an image of a galloping horse on the watch face). Optionally, as shown in blocks 414 and 416, the wearable device 100 could transmit the display theme to the companion device 200, and the companion device 200 can implement the theme on its display 210.

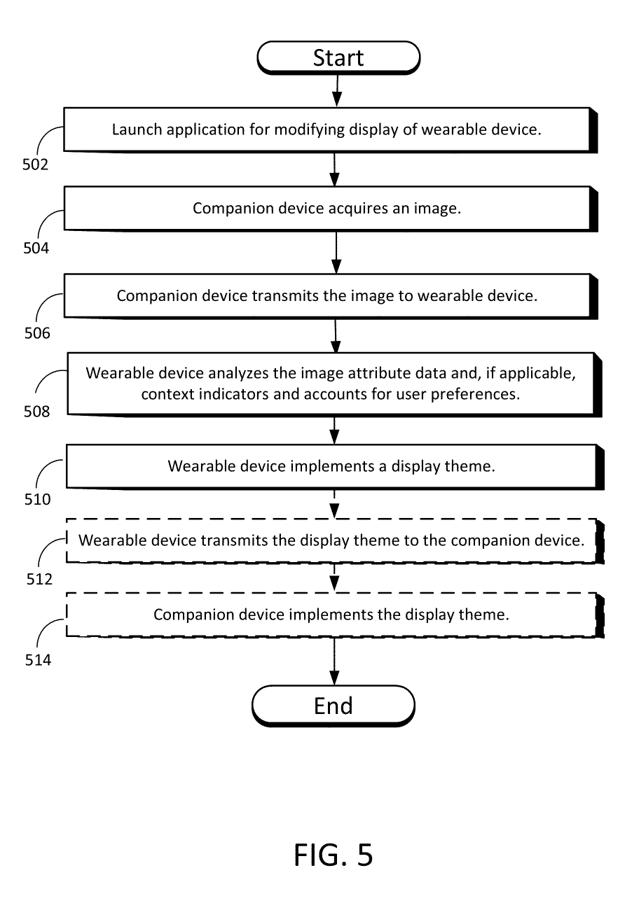

Turning to FIG. 5, operation of the wearable device 100 and the companion device 200 according to another embodiment is described. The operation according to the embodiment shown in FIG. 5 is similar to the embodiment described with respect to FIG. 4. However, in the embodiment of FIG. 5, the companion device 200 transmits the image to the wearable electronic device 100 without first analyzing the attribute data of the image. At block 502, the wearable electronic device 100 or the companion device 200 launches (e.g., in response to input from the user 300) an application stored in the memory 106 of the wearable electronic device 100 or in the memory 208 of the companion device 200, the purpose of which is to modify the appearance of the display 110 of the wearable electronic device 100. At block 504, the companion device 200 acquires an image of the user 300 using the camera 212, either automatically or in response to user input (e.g., after prompting the user to take a self-portrait). At block 506, the companion device 200 transmits the image to the wearable device 100. Blocks 508, 510, 512, and 514 are identical to blocks 410, 412, 414, and 416 of FIG. 4, which have previously been described.

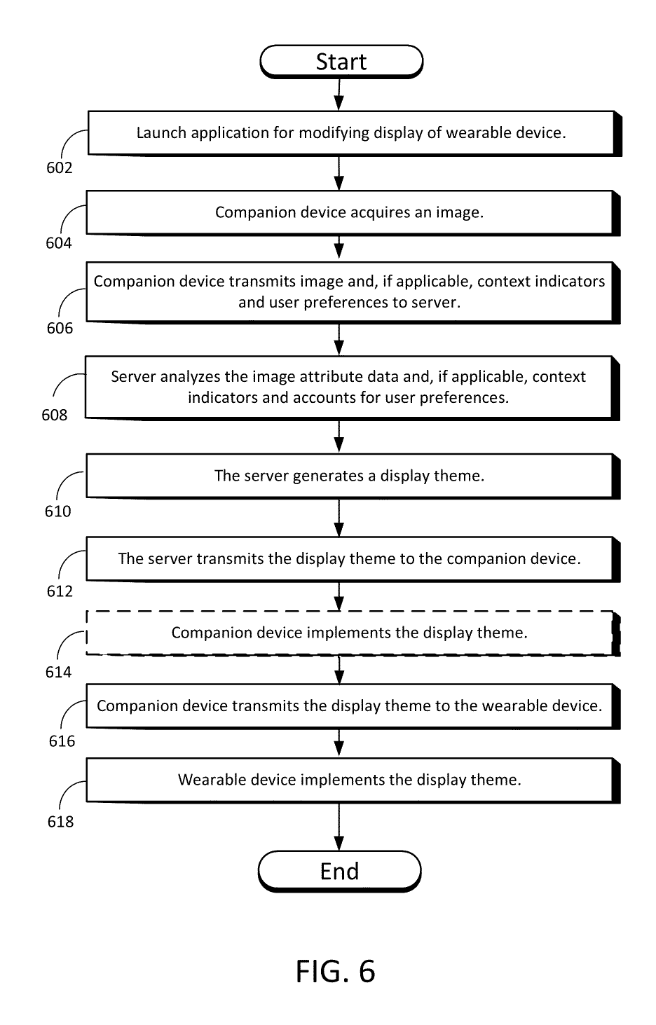

Turning to FIG. 6, operation of the wearable device 100 and the companion device 200 according to still another embodiment is described. The embodiment of FIG. 6 transfers much of the processing to the server 304, rather than relying upon the wearable electronic device 100 or the companion device 200. At block 602, the wearable electronic device 100 or the companion device 200 launches (e.g., in response to input from the user 300) an application stored in the memory 106 of the wearable electronic device 100 or in the memory 208 of the companion device 200, the purpose of which is to modify the appearance of the display 110 of the wearable electronic device 100. At block 604, the companion device 200 acquires an image of the user 300 using the camera 212, either automatically or in response to user input (e.g., after prompting the user to take a self-portrait). At block 606, the companion device 200 transmits the image to the server 304 via the public network 302 (e.g., over the network transceiver 206). At block 608, the server 304 performs the functions that the wearable device 200 performed at block 410 of FIG. 4 and block 508 of FIG. 5, which are described above.

At block 610, the server 304 generates a display theme based on the analysis conducted in block 608. At block 612, the server 304 transmits the display theme to the companion device 200 via the public network 302. Optionally, at block 614, the companion device 200 implements the display theme. At block 616, the companion device 200 transmits the display theme to the wearable device 100. At block 618, the wearable device 100 implements the display theme.

While one or more embodiments of the have been described with reference to the figures, it will be understood by those of ordinary skill in the art that various changes in form and details may be made therein without departing from their spirit and scope of as defined by the following claims.

What is claimed is:

1. A method, on a wearable electronic device, of implementing a display theme of the wearable electronic device, the method comprising:
wirelessly receiving, from a companion device, attribute data of an image captured by the companion device;
generating a display theme based on the received attribute data; and
changing a display of the wearable electronic device from a first display theme to a second display theme.

2. The method of claim 1, further comprising:
based on the received attribute data, presenting a plurality of display themes to a user for selection; and
receiving a user selection of a display theme of the plurality,
wherein changing a display of the wearable electronic device from a first display theme to a second display theme comprises changing the display theme from a first display theme to the selected display theme.

3. The method of claim 2, further comprising:
storing the selected user interface theme in a memory;
creating a history of selected user interface themes; and
learning user preferences based on the history of selected user interface themes,
wherein the plurality of display themes presented to the user for selection is based on the learned user preferences.

4. The method of claim 1, wherein the image is an image of a user and the attribute data of the image comprises a color of clothing worn by the user.

5. The method of claim 1, wherein changing a display of the wearable electronic device from a first display theme to a second display theme comprises changing the display theme from a first display theme to a second display theme based in part on a context indicator.

6. The method of claim 5, wherein the context indicator is one or more of a location, the weather, a time of day, crowd-sourced data, calendar data, a heart rate, a pre-determined combination of indicators, and an activity state of the user.

7. The method of claim 1, wherein the companion device is a smart phone.

8. The method of claim 1, wherein the wearable electronic device is a wrist watch.

9. A method, on a companion electronic device paired with a wearable electronic device, of implementing a display theme of the wearable electronic device, the method comprising:
acquiring an image with a camera;
analyzing the image to determine attribute data of the image;
generating a display theme based on the attribute data of the image; and
providing instructions to the wearable electronic device to modify its appearance based on the generated display theme.

10. The method of claim 9, further comprising:
presenting a plurality of display themes to a user for selection; and
receiving a selection of a display theme of the plurality from the user,
wherein the instructions to the wearable electronic device are based on the selected display theme.

11. The method of claim 9, wherein the image is an image of a user and the attribute data of the image comprises a color of clothing worn by the user.

12. The method of claim 9, wherein generating a display theme comprises generating a display theme based in part on a context indicator.

13. The method of claim 12, wherein the context indicator is one or more of a location, the weather, a time of day, crowd-sourced data, calendar data, a heart rate, a pre-determined combination of indicators, and an activity state of the user.

14. A method, on a companion electronic device paired with a wearable electronic device, of implementing a display theme of the wearable electronic device, the method comprising:
acquiring an image with a camera;
transmitting the image to a remote server;
receiving, from the server, a display theme; and
providing instructions to the wearable electronic device to modify its appearance based on the display theme.

15. The method of claim 14, further comprising transmitting a context indicator to the remote server, wherein the display theme is based in part on the context indicator.
